(19) United States
(12) Patent Application Publication
(10) Pub. No.: US 2009/0028037 A1
(43) Pub. Date: Jan. 29, 2009

(54) OPTICAL SCANNING DEVICE

(75) Inventors: Coen Adrianus Verschuren, Eindhoven (NL); Ferry Zijp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,946

(22) PCT Filed: Jul. 25, 2005
(86) PCT No.: PCT/IB05/52491

§ 371 Date: Feb. 20, 2007

(30) Foreign Application Priority Data
Aug. 23, 2004 (EP) 04104037.9

(51) Int. Cl. G11B 7/135

(52) U.S. Cl. 369/112.24; G9B/7.112

(57) ABSTRACT

An optical scanning device for scanning a record carrier (22), the record carrier having an outer face (24), wherein the optical scanning device comprises a radiation source system (2) arranged to generate radiation (3); an objective system (20) having an exit face (24), the objective system being arranged between the radiation source system and the record carrier; a radiation detector arrangement for generating detector signals representing information detected in the radiation after interaction with the record carrier; and a position control system (42) for controlling a gap size of a gap between the exit face of the objective system and the outer face of the record carrier, the position control system providing for evanescent coupling of the radiation across the gap. The optical scanning device is arranged to process the detector signals to generate error signals suitable for controlling characteristics of the device during scanning of a record carrier, the error signals including a first error signal (E₁) for use by the position control system for controlling the gap size. The optical scanning device is characterised in that the optical scanning device is arranged to generate a second error signal (E₂), different to the first error signal, for use by the position control system for controlling the gap size.

### FIELD OF THE INVENTION

The present invention relates to an optical scanning device for scanning record carriers, in particular for scanning record carriers using evanescent coupling of radiation.

### BACKGROUND OF THE INVENTION

In a particular type of high-density optical scanning device, a solid immersion lens (SIL) is used to focus a radiation beam to a scanning spot onto an information layer of a record carrier. A certain size of a gap between the exit face of the SIL and the outer face of the record carrier, for example 25 nm, is desirable to allow evanescent coupling of the radiation beam from the SIL to the record carrier. Evanescent coupling may otherwise be referred to as frustrated total internal reflection (FTIR). Such systems are known as near-field systems, deriving their name from the near field formed by the evanescent wave at an exit face of the SIL. An exemplary optical scanning device may use a radiation source which is a blue laser and emits a radiation beam having a wavelength of approximately 405 nm.

During scanning of the record carrier the evanescent coupling between the exit face of the SIL and the outer face of the record carrier should be maintained. An efficiency of this evanescent coupling may vary with a change in the size of the gap between the exit face and the outer face. With an increase away from a desired gap size the coupling efficiency will tend to decrease and consequently a quality of the scanning spot will also decrease. If the scanning procedure involves reading data from the record carrier, for example, this decrease in efficiency will result in a decrease in the quality of the data being read, possibly with the introduction of errors into the data signal.

Near-field systems have small mechanical tolerance margins which impose strict restrictions and limitations on the design and operation of components of such systems. The small gap size required for efficient evanescent coupling helps to cause these small margins.

Prior to performing a scanning procedure of a record carrier, it is common for optical scanning devices to perform a start-up procedure. Such a start-up procedure ensures that components of the optical scanning device are correctly positioned so that the scanning procedure, for example reading data from or writing data to the record carrier, may be performed at a high level of quality.

A start-up procedure may involve moving an objective system of the scanning device from a standby position to a scanning position. This can include a combination of an approach procedure using an open loop operation and a pull-in procedure using a closed loop operation and ensures that the size of the gap between the objective system and the record carrier is optimised for the scanning procedure. The objective system lies in the standby position when, for example, no record carrier for scanning is arranged within the optical scanning device, or the power to the record carrier is switched off or is set to a standby mode, or an opening of the scanning device, through which a record carrier may be inserted within the scanning device, is open. In the standby position, the objective system may be arranged so that delicate optical components of the objective system are protected from impacts, scratches and any contamination from dust, for example.

An optical scanning device which provides such a pull-in procedure is disclosed by Sony, herein referenced: T. Ishimoto et al. Proceedings of Optical Data Storage 2001 in Santa Fe. This optical system generates a Gap Error Signal (GES) which is used during both a pull-in procedure and during a scanning procedure to adjust a gap size between an objective system and a record carrier. The GES is used to control a servo system which adjusts the gap size. In the pull-in procedure the objective system is moved by the servo system to an optimum position for the scanning procedure. The GES provides information to the servo system of a position of the objective system corresponding to a relatively small gap size. With the objective system being in a stand-by position which corresponds to a relatively large gap size, the GES does not provide information to the servo system of the position of the objective system. During the approach procedure, the movement of the objective system towards the record carrier for a relatively large gap size is not controlled. As a consequence the objective system may be moved beyond the optimum position and may even collide with the record carrier. Such a collision may result in damage, or failure of, either the objective system or the record carrier.

### SUMMARY OF THE INVENTION

It is an object of the present invention to provide an optical scanning device for optimally scanning a record carrier using evanescent coupling by accurately and efficiently positioning an objective system with respect to the record carrier.

According to a first aspect of the present invention, there is provided an optical scanning device for scanning a record carrier, said record carrier having an outer face, wherein said optical scanning device comprises:
a) a radiation source system arranged to generate radiation;
b) an objective system having an exit face, said objective system being arranged between said radiation source system and said record carrier;
c) a radiation detector arrangement for generating detector signals representing information detected in the radiation after interaction with the record carrier; and
d) a position control system for controlling a gap size of a gap between the exit face of the objective system and the outer face of the record carrier, the position control system providing for evanescent coupling of the radiation across said gap,
   wherein the optical scanning device is arranged to process said detector signals to generate error signals suitable for controlling characteristics of the device during scanning of a record carrier, said error signals including a first error signal for use by the position control system for controlling said gap size,
   characterised in that the optical scanning device is arranged to generate a second error signal, different to said first error signal, for use by the position control system for controlling said gap size.

By providing two different error signals for controlling the gap size, improved positioning of the objective system relative to the record carrier is provided. Namely, the two different error signals will have different characteristics which can be employed selectively during different procedures involving such positioning.

For near-field systems using evanescent coupling to scan a record carrier, it is important that an objective system is positioned optimally with respect to the record carrier to ensure that an efficient evanescent coupling is achieved. This ensures that scanning of the record carrier, for example in writing data to or reading data from the record carrier, is performed to a high level of quality. An optimum positioning of the objective system involves moving the objective system in a controlled manner from a position corresponding to a relatively large gap size to a position corresponding to a relatively small gap size, very close to the record carrier.

In embodiments of the present invention, said position control system is arranged to use said second error signal to control said gap size during a start-up procedure in which said position control system moves said objective system, relative to said record carrier, from a first position, in which there is no efficient evanescent coupling across said gap, to a second position, in which there is efficient evanescent coupling of the radiation across said gap.

It has been realised that with the use of the first error signal for controlling the gap size during scanning of a record carrier, a suitable second, different, error signal may be used to control the gap size during a start-up procedure of the objective system. By using a second error signal, from which a relatively early indication of proximity to the record carrier can be obtained, an improved start-up procedure is possible. Namely, it is possible during the start-up procedure to move the objective system in a controlled and accurate manner, from a position corresponding to a relatively large gap size to an optimum position for scanning a record carrier, relatively quickly whilst reducing the danger of collision during the moving of the objective system to the record carrier.

In accordance with a further aspect of the present invention, there is provided a record carrier for use in an optical scanning device, said record carrier having an outer face, wherein said optical scanning device comprises:
a) a radiation source system arranged to generate radiation;
b) an objective system having an exit face, said objective system being arranged between said radiation source system and said record carrier;
c) a radiation detector arrangement for generating detector signals representing information detected in the radiation after interaction with the record carrier;
d) a first position control system for controlling a gap size of a gap between the exit face of the objective system and the outer face of the record carrier, the position control system providing for evanescent coupling of the radiation beam across said gap; and
e) a second position control system for controlling positioning of said objective system across the outer face of the disc,
   wherein said record carrier comprises a scanning area in which said objective system is positionable using said second position control system,
   wherein said scanning area includes:
   one or more data areas for storing data in data tracks, said data tracks having a predetermined width; and
   one or more non-data areas arranged to provide scanning characteristics whereby said radiation detector arrangement is able to generate an error signal with which said first position control system is able to control said gap size, said one or more non-data areas having a width greater than said predetermined data track width.

The error control signal provided by the non-data areas, which can be flat, or so-called “mirror surfaces” or pregrooves, allows the first position control system to accurately and controllably move the objective system to the optimum position for scanning the record carrier.

In accordance with a further aspect of the present invention, there is provided a method of scanning a record carrier which comprises scanning said record carrier using said optical scanning device, said method comprising:
positioning said objective system in a non-data area using said second position control system; and
using said first position control system to control said gap size, using an error control signal generated by interact ion of said radiation with said non-data area.

Having positioned the objective system using the second position control system, the gap size can be controlled effectively by the first position control system using the error signal provided by scanning the non-data area of the record carrier, well before a position of the objective system for evanescent coupling during a scanning procedure is attained.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an optical scanning device in accordance with an embodiment of the present invention.

FIG. 2 shows schematically a record carrier in accordance with an embodiment of the present invention.

FIGS. 3A and 3B show as a flow diagram, steps of a start-up procedure and a scanning procedure in accordance with an embodiment of the present invention.

FIG. 4 shows, graphically, calculated error signals of an optical scanning device in accordance with embodiments of the present invention.

FIG. 5 shows, graphically, calculated error signals of an optical scanning device in accordance with embodiments of the present invention.

FIG. 6 shows, graphically, experimental error signals in accordance with embodiments of the present invention.

FIG. 7 shows, graphically, experimental error signals in accordance with embodiments of the present invention.

### DETAILED DESCRIPTION OF THE INVENTION

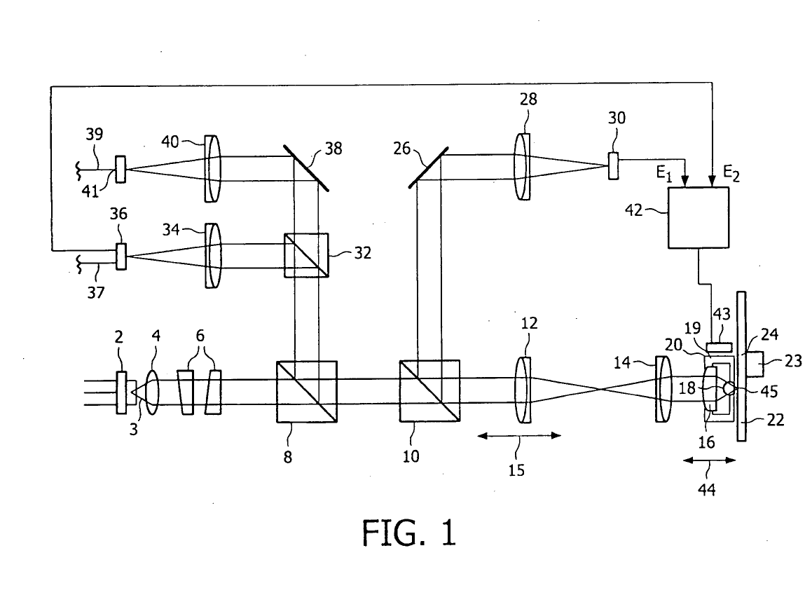

FIG. 1 shows schematically an optical scanning device for scanning a record carrier in accordance with an embodiment of the present invention.

The optical scanning device comprises a radiation source system which is arranged to generate radiation. In this embodiment the radiation source is a laser 2 and the radiation is a radiation beam 3 having a predetermined wavelength λ, for example approximately 405 nm. During both a start-up procedure and a record carrier scanning procedure of the optical scanning device, the radiation beam 3 passes along an optical axis (not indicated) of the optical scanning device and is collimated by a collimator lens 4 and its cross-sectional intensity distribution shaped by a beam shaper 6. The radiation beam 3 then passes through a non-polarising beam splitter 8, followed by a polarising beam splitter 10 and has a focus introduced between a first focus adjustment lens 12 and a second focus adjustment lens 14. An optimal adjustment of a focus position of the radiation beam 3 on the record carrier is achieved by moving the first focus adjustment lens 12 in a focus adjustment direction 15. An objective system 20 of the optical scanning device comprises an objective lens 16 which introduces a focusing wavefront into the radiation beam 3. The objective system 20 further comprises a solid immersion lens SIL 18 which is fixed to the objective lens 16 by a supporting frame 19. In this embodiment the SIL 18 has a conical super-hemispherical shape with the exit face 45 facing the outer face 24. An NA of the SIL is 1.9.

The supporting frame 19 ensures that an alignment and a separation distance of the objective lens 16 with the SIL 18 is maintained. The objective system has an exit face 45 which is planar and is an exit face 45 of the SIL 18. After the introduction of the focus, the radiation beam passes through the objective system 20 and forms a radiation beam spot on the record carrier 22. The radiation beam which falls onto the record carrier 22 has a linear polarisation.

A record carrier 22 to be scanned by the optical scanning device is arranged on a mounting element 23 within the optical scanning device. The mounting element 23 includes a clamping arrangement (not indicated) which ensures that the record carrier 22 is held rigidly and correctly in place on the mounting element 23 during scanning. With the record carrier 22 being rigidly held in place, the mounting element 23 provides for a translation, in this embodiment a rotation, of the record carrier 22 in relation to a radiation scanning spot being used to scan data tracks of the record carrier 22. The record carrier 22 has an outer face 24 which faces the exit face 45 of the SIL 18. In this embodiment the record carrier 22 is formed of silicon and the outer face 24 is a surface of an information layer of the record carrier 22 through which the radiation beam enters the record carrier 22. The objective system 20 is arranged between the radiation source 2 and the record carrier 22 and a gap between the exit face 45 and the outer face 24 has a gap size which is a distance between the exit face 45 and the outer face in a direction which is coincident with the optical axis OA.

The maximum information density that can be recorded, for example, on a record carrier scales inversely with the size of the radiation spot that is focused onto a scanning position on the information layer. The minimum spot size is determined by the ratio of two optical parameters: the wavelength λ of the radiation and a numerical aperture (NA) of the objective system. The NA of an objective lens such as a SIL is defined as NA=n sin (θ), with n the refractive index of the medium in which the radiation beam is focused and θ the half angle of the focused cone of radiation in that medium. It is evident that the upper limit for the NA of objective lenses that focuses in air or through a plane parallel plate such as a planar record carrier, is unity. The NA of a lens can exceed unity if the radiation beam is focused in a high index medium and passes to an object without refraction at the medium-air-medium interface between the lens and the object. This can be achieved, for example, by focusing in the centre of an exit face of a SIL having a hemispherical shape, the SIL being in close proximity to the object. In this case the effective NA is NA_{eff}=n NA₀ with n the refractive index of the hemispherical lens and NA₀ the NA in air of the focusing lens. A possibility to further increase the NA is the use of a SIL having a super-hemispherical shape in which the super-hemispherical SIL refracts the radiation beam towards the optical axis and focuses it below the centre of the super-hemisphere. In the latter case the effective NA is NA_{eff}=n² NA₀. It is important to note that an effective NA_{eff} larger than unity is only present within an extremely short distance (also called the near-field) from the exit face of the SIL, where an evanescent wave exists. In this embodiment the exit face is the last refractive surface of the objective system before the radiation impinges on the object. The short distance is preferably approximately equal to or less than one tenth of the wavelength λ of the radiation beam.

When the object is an optical record carrier and an outer face of the optical record carrier is arranged within this short distance, radiation is transmitted from the SIL to the record carrier by evanescent coupling. This means that during writing or read-out of a record carrier, the gap size between the SIL and record carrier should be smaller than a few tens of nanometres, for example, about 25 nm for a system using a blue laser radiation source to generate a radiation beam having a wavelength A of approximately equal to 405 nm and an NA of the objective system of 1.9.

The optical scanning device includes a plurality of optical detection paths. In a first optical detection path there is arranged a folding mirror 26 and a condenser lens 28 for focusing a detection radiation beam onto a first detector 30.

In a second, different, detection path there is arranged a non-polarising beam splitter 32, a condenser lens 34 for focusing a detection radiation beam onto a second detector 36, a folding mirror 38 and a condenser lens 40 for focusing a detection radiation beam onto a third detector 41.

The first detector 30, and the second detector 36 and the third detector 41 constitute a radiation detector arrangement for generating detector signals representing information detected in the radiation after interaction with the record carrier 22.

A portion of the reflected rays passing along the second detection path pass via the non-polarising beam splitter 32 and the condenser lens 34 to the second detector 36. The signal processing circuitry in the second detector 36 is arranged to produce a main data signal 37 which is produced during the scanning of data tracks on the record carrier 22 during a read-out procedure.

The optical scanning device includes a first position control system 42 to which the first detector 30 and the second detector 36 are electrically connected. The first position control system 42 is arranged for controlling the gap size between the exit face. 45 of the objective system and the outer face 24 of the record carrier 22.

The first position control system 42 includes a servo control system (not indicated) and an actuator 43. The actuator 43 is arranged to move the objective system 20 in a gap size adjustment direction 44. In this embodiment the actuator comprises a plurality of permanent magnets and conducting coils. The coils are positioned in the magnetic field of the permanent magnets. The coils conduct an electrical current and produce an actuating force that is able to move the objective system 20 in the gap size adjustment direction 44. Alternatively the actuator may comprise piezo electric actuators to generate an actuating force to move the objective system 20. The first position control system 42 provides for evanescent coupling of the radiation across the gap by controlling the actuator 43 to move the objective system 20 to a position where efficient evanescent coupling will occur.

The radiation detectors 30, 36, 41 include signal processing circuitry (not indicated) which is arranged to process the detector signals in order to generate error signals for controlling characteristics of the device during scanning of the record carrier. The error signals include a first error signal E₁ which is derived from radiation passing along the first optical detection path, and is for use by the first position control system 42 for controlling the gap size. The error signals also include a second error signal E₂ which is derived from radiation passing along the second optical detection path, and is for use by the first position control system 42 for controlling the gap size. The radiation passing along the first optical detection path and the radiation passing along the second optical detection path are orthogonally polarised with respect to each other.

The optical scanning device further comprises a second position control system (not indicated) for controlling a radial position of the objective system 20 across tile outer face 45 of the record carrier 22. The second position control system includes a coarse positioning mechanism, such as a linear displacement mechanism or a rotary arm for positioning the objective system 20 prior to a start-up procedure and for coarse tracking during scanning, and a fine positioning mechanism, such as tracking actuators, for fine tracking during scanning. The third detector 41 is a push-pull detector which includes signal processing circuitry to generate a push-pull error signal 39 which is used by the second position control system to maintain a radial tracking of the scanning radiation spot on a data track of the record carrier 22.

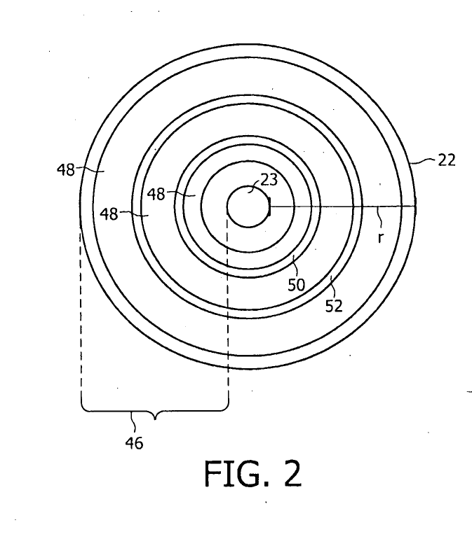

FIG. 2 shows schematically a structure of the record carrier which in this embodiment is an optical disc and has a scanning area 46 with a radial extent. The second position control system is used to position the objective system 20 in this scanning area so that the record carrier 22 may be scanned at a desired point. The scanning area includes one or more data areas 48 in which an information layer is adapted for storing data in data tracks (not indicated). Each data track within the data areas 48 has a predetermined width (not indicated) along a direction coincident with a radius r of the record carrier. The record carrier 22 further comprises one or more non-data areas in which the information layer is flat (a so-called “mirror surface”) or a pregroove, which may have a wobble, and which does not contain any structures that lead to a modulation of the first or second error signals E₁, E₂. In this embodiment two non-data areas 50, 52, which are arranged to provide scanning characteristics whereby the radiation detector arrangement is able to generate an error signal, in this embodiment the second error signal E₂, with which the first position control system 42 is able to control the gap size. The one or more non-data areas 50, 52 each have a width in a direction coincident with the radius which is greater than the predetermined data track width. This provides a tolerance margin such that the error signal is provided when scanning the non-data areas 50, 52 even when the radiation beam spot can not be accurately positioned to within a track width on the outer face 24. Before the start-up procedure is conducted, no fine tracking is possible, and coarse tracking can only be conducted by the second position control system to within an accuracy of a factor of ten, or a factor of a hundred, or more track widths. The non-data areas 50, 52, do not have any structural features that lead to a modulation of the first or second error signals E₁, E₂.

In preferred embodiments of the invention, the scanning area 46 of the record carrier 22 includes a plurality of data areas 48 and at least one non-data area is located between two of the plurality of data areas 48. In this way, the non-data area can be used during a start-up procedure, and a target data track to be scanned can be reached relatively quickly after start-up, irrespective of the location of the target data track on the record carrier. In this embodiment the scanning area 46 includes a plurality of non-data areas, including a first and a second non-data area 50, 52 which are located at different positions across the outer face 24. In this embodiment the first and second non-data areas 50, 52 are concentric and are located at different radial positions across the outer face 24. In this way, a target data track can be reached even more quickly, by accessing a non-data area 50, 52 selected according to proximity to the target data track for use during the start-up procedure.

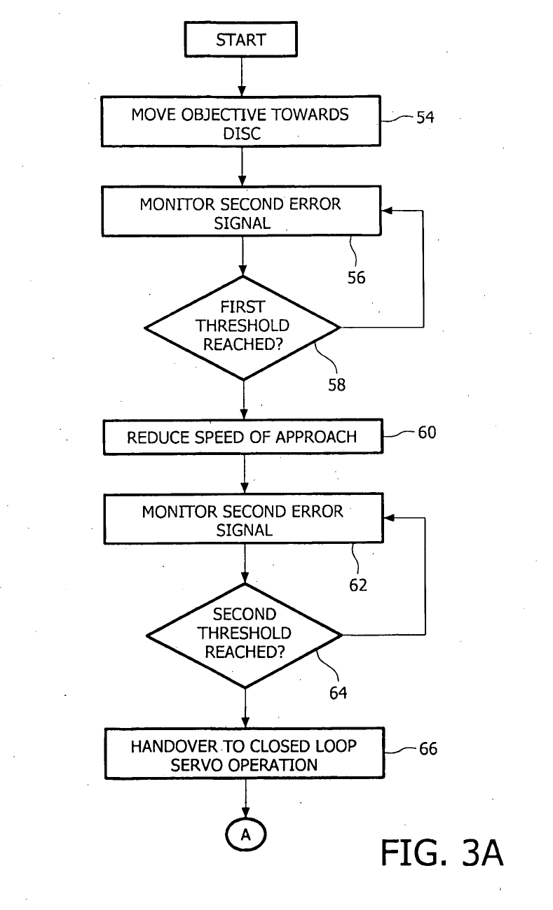

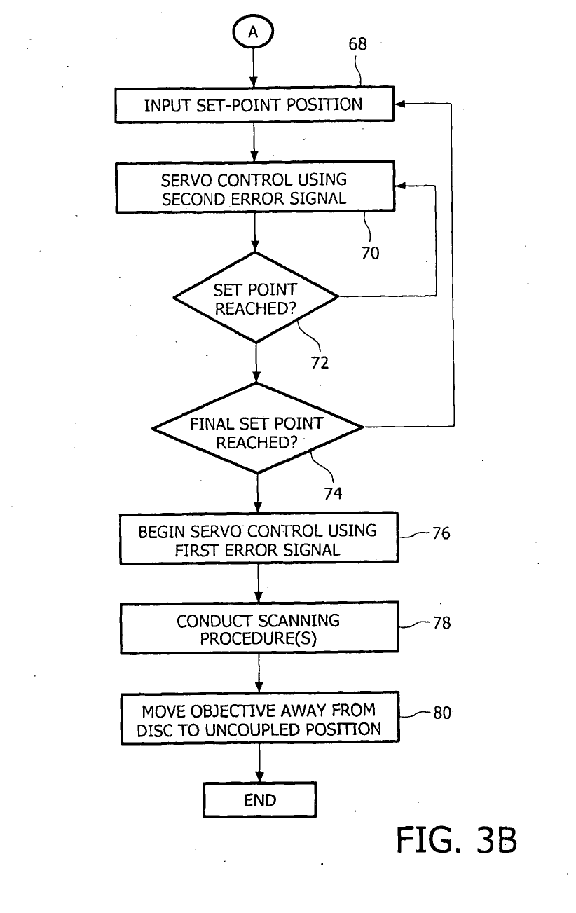

FIGS. 3A and 3B show steps of a start-up procedure and a scanning procedure of the optical scanning device in accordance with an embodiment of the present invention.

According to this embodiment and during a start-up procedure of the optical scanning device, the first position control system is arranged to use the second error signal E₂ to control the gap size. The start-up procedure comprises an approach procedure and a separate pull-in procedure. The approach procedure uses an open loop operation. The pull-in procedure uses a closed loop operation of the servo control system. In the start-up procedure, the radiation beam 3 generated by the radiation source 2 is directed onto the outer face 24 as a radiation beam spot, as explained earlier. The second position control system varies the position of the objective system 20 to ensure that the radiation beam spot falls in one non-data area 50, 52 of the record carrier 22.

In the start-up procedure the objective system 20 is moved, relative to the record carrier 22 along the gap size adjustment direction 44. The objective system 20 is moved from a first position to a second position. At the first position, which is a stand-by position, there is no efficient evanescent coupling of the radiation across the gap between the exit face 45 and the outer face 24. At the second position, which is an optimum scanning position, there is efficient evanescent coupling of the radiation across the gap.

In a first step 54 of the start-up procedure and during the approach procedure, the first position control system is arranged to use the second error signal E₂ to control an approach of the objective system 20 from the first position towards the outer face 24. This approach is performed along the gap size adjustment direction 44. The first position control system controls this approach prior to a control of the gap size by the servo control system.

During this first step 54 a relatively high portion of rays of the radiation beam interact with the non-data areas 50, 52. In this embodiment this interaction is a reflection by one non-data area 50, 52. Additionally, with a relatively large gap size, no efficient evanescent coupling occurs across the gap. As a consequence a relatively high portion of the rays are also reflected by the exit face 45 due to total internal reflection (TIR) within the SIL 18. A relatively low portion of the rays are absorbed by the record carrier 22, following transmission across the outer face 24. The rays may be absorbed by a material from which the record carrier 22 is formed. The rays may also be absorbed by the outer face 24 itself due to a destructive interference of the rays upon interaction with structural features of the entrance layer 24 and/or information layer such as pits and embossments.

The reflected portions of rays pass along the optical axis OA through the objective system 20, through the second and first focus adjustment lenses 14, 12, via the polarising beam splitter 10 and along the first detection path to the first detector 30 via the folding mirror 26 and the condenser lens 28. Radiation of the reflected rays falling on the first detector 30 has a radiation intensity. The first detector 30 detects this radiation intensity and generates the first error signal E₁. A magnitude of the first error signal E₁ is related to a magnitude of the intensity, therefore radiation having a relatively high intensity results in generation of a first error signal E₁ having a relatively high magnitude. The radiation rays passing along the first detection path have a polarisation which is perpendicular the polarisation of the radiation beam falling on the record carrier 22. The first error signal E₁ is used during the scanning procedure of this embodiment, as explained earlier.

A portion of the reflected rays which do not pass along the first detection path pass through the polarising beam splitter 8 and along the second detection path to the second detector 36 via the non-polarising beam splitter 32 and the condenser lens 34. Radiation of the reflected rays falling on the second detector 36 also has a radiation intensity. The second detector 36 detects the error, signal provided by scanning one non-data area 50, 52 as this radiation intensity and generates the second error signal E₂. A magnitude of the second error signal E₂ is related to a magnitude of the intensity, therefore radiation having a relatively high intensity results in generation of a second error signal E₂ having a relatively high magnitude. The radiation rays passing along the second detection path have a polarisation which is parallel to the polarisation of the radiation beam falling on the record carrier 22.

In a further step 56 the first position control system monitors the second error signal E₂. As the objective system 20 is moved closer to the record carrier 22 and the gap size decreases, the intensity of radiation passing along the second detection path increases. As a result the magnitude of the second error signal E₂ also increases. During this step 56 of the start-up procedure the radiation beam spot on the outer face 24 is defocused. Consequently, not all radiation rays which are reflected by the outer face 24 are reflected directly into the objective system 22 and pass along to the second detector 36. By moving the objective system 20 closer to the record carrier 22, more of the rays are reflected directly into the objective system 20, pass along to the second detector 36 and the magnitude of the second error signal E₂ increases as a result.

When the first position control system identifies that a first threshold T₁ of the second error signal E₂ has been reached 58 the speed of moving the objective system 20 towards the record carrier 22 is reduced 60. The first threshold T₁ corresponds to a peak magnitude of the second error signal E₂ when a peak number of radiation rays are reflected by the outer face 24 directly into the objective system 20 and are detected by the second detector 36.

With the first position control system now moving the objective system 20 towards the outer face 24 at a reduced speed, the first position control system monitors 62 the second error signal E₂ When the first position control system identifies that a second threshold T₂ of the second error signal E₂ has been reached 64, control of the gap size by moving the objective system 20 towards the outer face 24 is handed over 66 to a closed loop operation of the servo control system. The first position control system is arranged to use the second error signal E₂ as an input to the servo control system during the pull-in procedure of the start-up procedure. The second threshold T₂ corresponds to a magnitude of the second error signal E₂ which is indicative of the objective system 20 having a position such that the gap size allows for efficient evanescent coupling to occur across the gap between the exit face 45 and the outer face 24. With the second error signal E₂ having a magnitude corresponding to the second threshold T₂ a desired set-point position of the objective system 20 is input 68 into the servo control system. The desired set-point position is a desired position along the optical axis OA of the objective system 20 relative to the outer face 24.

With the closed feedback loop of the servo control system, the servo control system moves the objective system 20 towards the outer face 24 using the second error signal E₂ to control 70 the current position of the objective system 20. The servo control system monitors the second error signal E₂. The servo control system may decrease the speed at which the objective system 20 is moved towards the outer face 24 in accordance with a magnitude of the second error signal E₂. From the magnitude of the second error signal E₂ the servo control system identifies 72 whether the objective system 20 has reached the desired set-point position. The movement of the objective system 20 towards the outer face 24 is continued until it is identified that the objective system 20 has reached the desired set-point position. At this point the servo control system assesses whether a final set-point position has been reached 74. The final set-point position corresponds to a position along the optical axis OA of the objective system 20 relative to the outer face 24 providing a desired gap size and which will allow the record carrier 22 to be accurately scanned by the optical scanning device during the scanning procedure.

If the final set-point has not been reached the servo control system inputs 68 a further, different, desired set-point position which corresponds to a nearer position of the objective system 20 to the outer face 24. Similar to that described earlier, the servo control system controls movement of the objective system 20 towards the outer face 24 using the second error signal E₂ until the further, different, desired set-point position is reached 72. The servo control system assesses whether the final set-point position has been reached 74. If this is not the case the servo control system iteratively inputs 68 a further, different, set-point position and moves the objective system 20 towards the outer face 24 in the manner described earlier. The iterative process of inputting a new set-point position and moving the objective system 20 to this set-point position ensures that the servo control system does not move the objective system 20 in such a way that the objective system 20 overshoots the final set point and possibly collides with the outer face 24.

Once the servo control system identifies that the final set-point has been reached 74 the servo control system switches its control from using the second error signal E₂ and begins 76 to control the servo control system using the first error signal E₁.

The optical scanning device then conducts 78 a scanning procedure, for example a reading of data from, or a writing of data to, the record carrier 22. During the scanning procedure the second position control signal moves the objective system 20 across the outer face 24 so that the radiation beam spot falls on a data track in one data area 48 of the information layer of the record carrier 22. The mounting element 23 rotates so that the record carrier 22 is rotated with respect to the radiation beam spot. The radiation beam spot is focused onto the information layer 24 and its position across the outer face 24 is controlled by the second position control system so as to accurately follow the data track being scanned. The radiation beam interacts with the information layer and rays of the radiation beam are reflected by the information layer into the objective system 20.

A portion of these reflected rays pass along the first detection path to the first detector 30, in accordance with the explanation given earlier. A significant fraction of this reflected radiation becomes elliptically polarised after reflection at the exit face 45 and the outer face 24. This creates the well-known “Maltese Cross” pattern when the reflected radiation is observed through a polariser. The signal processing circuitry generates the first error signal E₁ in accordance with the detector signal of the first detector 30. This generation is performed by integrating all the light of the Maltese Cross pattern. The first error signal E₁ is derived from a low-frequency, for example DC to approximately 30 kHz, part of the radiation being detected by the first detector 30. The servo control system controls the gap size using the first error signal E₁. The servo control system monitors the first error signal E₁ and if, during the scanning procedure, the position of the objective system 20 relative to the outer face 24 varies from the final set-point position, the servo control adjusts the position of the objective system 20 along the gap size adjustment direction 44 so that the desired gap size is maintained. This control of the gap size maintains an efficient evanescent coupling during the scanning procedure. A change in a magnitude of the first error signal E₁ indicates to the servo control system a change in a position of the objective system 20 from the final set-point position.

Upon completion of the scanning procedure, the objective system 20 is moved 80 in a direction away from the outer face 24 along the gap size adjustment direction 44. The objective system 20 is moved to a position where efficient evanescent coupling across the gap can not occur. This position may for example be the stand-by position.

In a further embodiment of the present invention and during the start-up procedure, the first position control system is arranged to control the gap size selectively using the first error signal E₁ or the second error signal E₂. The first position control system uses the first error signal E₁ when the gap size is relatively small. The first position control system is arranged to control the gap size using the second error signal E₂ when the gap size is relatively large. The start-up procedure of this further embodiment is similar to that of the previously described embodiment and therefore only differences between the two embodiments will be described herein. During the start-up procedure and upon reaching the second threshold T₂ the servo control system continues to move the objective system 20 towards the outer face 24 along the gap size adjustment direction 44. Additionally the servo control system monitors a magnitude of the first error signal E₁. The first detector 30 generates the first error signal E₁ by detecting radiation reflected by one non-data area 50, 52. When the first error signal E₁ has a magnitude which corresponds to a third, different threshold T₃, the position of the objective system 20 provides a gap size which allows efficient evanescent coupling. Once the third threshold T₃ has been reached control of the servo control system is changed from using the second error signal E₂ to the first error signal E₁. In a similarly iterative process to that described earlier for the previous embodiment, a desired set-point position is input by the servo control system, the objective system 20 is moved until this desired set-point position is reached and, if this desired set-point is not the desired final set-point position, a further, different desired set-point position is input until the objective system 20 reaches a desired final set-point position. Following this the scanning procedure is conducted using the first error signal E₁.

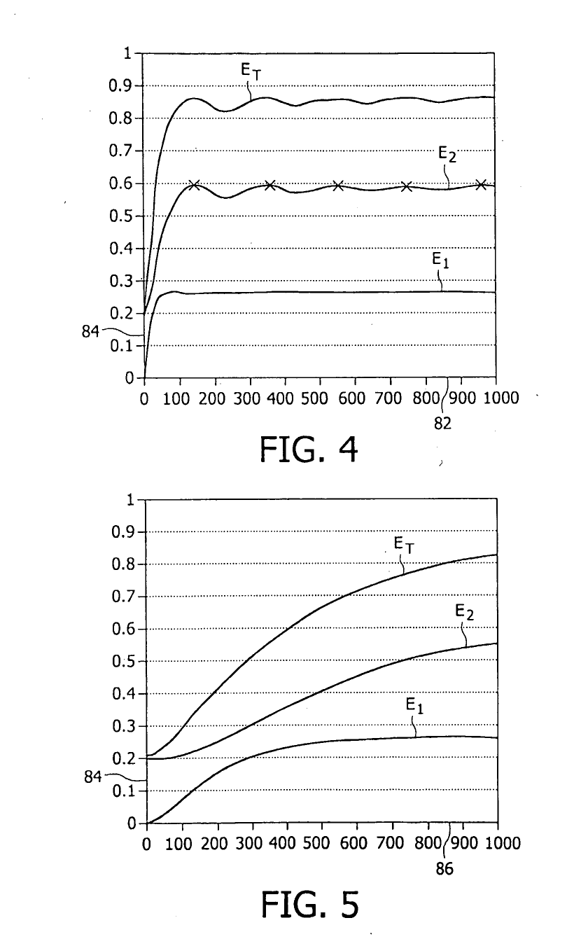

In accordance with the described embodiments of the present invention, FIG. 4 shows graphical plots illustrating a calculated variation of the first error signal E₁, the second error signal E₂ and a total error signal E_{T} with a variation of the gap size. The gap size in nanometres is plotted on a first axis 82, indicating a gap size having a range of 0 to 1000 nm, against a magnitude of error signal on a second axis 84 which is perpendicular the first axis 82. The magnitude of the error signal is shown as a fraction, of a total of 1, of reflected radiation rays by the outer face 24 and the exit face 45, which are detected by the first detector 30 for the first error signal E₁ and by the second detector 36 for the second error signal E₂. In FIG. 5 a first axis 86 is similar to the first axis 82 of the plot of FIG. 4, but has a larger scale and indicates a gap size having a range of 0 to 100 nm. Referring to FIGS. 4 and 5 the magnitude of the first error signal E₁ increases from a fraction of approximately 0.0 for a gap size of approximately 0.0 nm to a maximum fraction of approximately 0.26 for a gap size of approximately 50 nm. The magnitude of the second error signal E₂ increases from a fraction of approximately 0.2 for a gap size of approximately 0.0 nm to a maximum fraction of approximately 0.58 for a gap size of approximately 100 nm. From the second error signal E₂ the servo control system is able to determine a gap size of up to approximately 100 nm, whereas from the first error signal E₁ the servo control system is able to determine a gap size of up to 50 nm. The total error signal E_{T} is a sum of the fraction of the first and the second error signals E₁, E₂ for a given gap size. For gap sizes greater than approximately 100 nm the second error signal E₂ has an oscillation due to the Fabry-Perot effect.

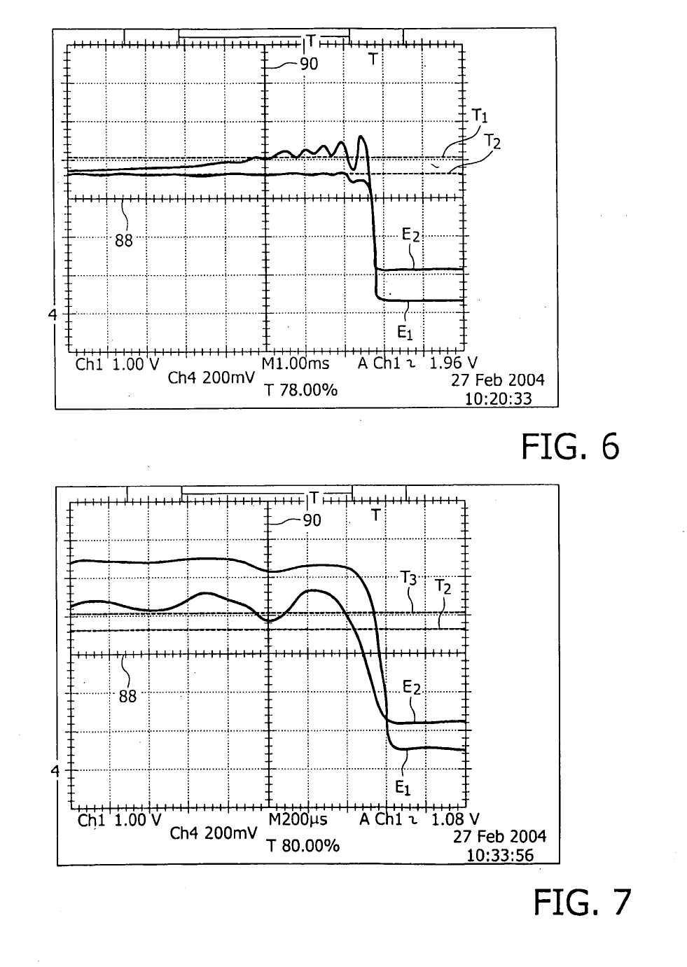

In accordance with the described embodiments of the present invention, FIGS. 6 and 7 show graphically experimental plots of a variation of the first and second error signals E₁ E₂ with the gap size. The gap-size is plotted on a first axis 88 and the magnitude of error signal is plotted on a second axis 90 which is perpendicular the first axis 88. In FIG. 6 the first and second thresholds T₁, T₂ are shown and in FIG. 7 the second and third thresholds T₂, T₃ are shown.

The above embodiments are to be understood as illustrative examples of the invention. Further embodiments of the invention are envisaged. In further embodiments of the present invention, the objective system comprises a different SIL. It is envisaged that such a different SIL may have a different shape to that described previously, for example a non-conical super-hemispherical shape, or a mesa super-hemispherical shape where the exit face is a protrusion of the SIL, or a hemispherical shape.

In the described embodiments of the present invention, the record carrier has an information layer and the outer face is a surface of this information layer. It is alternatively envisaged that the record carrier has an information layer and a cover layer. One surface of the cover layer is the outer face whereas the information layer is arranged on the other surface of the cover layer. In this alternative embodiment the optical scanning device is adapted so that during the scanning procedure the radiation beam is focused through the cover layer to a spot on the information layer. One such adaptation is a change in a thickness of the SIL along the optical axis.

The record carrier as described in the detailed embodiments of the present invention is formed of silicon. Alternatively, it is further envisaged that the record carrier is of a different construction and is formed of a plurality of layers including, for example for a read-only type disc, a polycarbonate layer and a metallic layer or a stack of dielectric layers. For a recordable type disc the plurality of layers is envisaged to include a polycarbonate layer and a layer formed of a material with a changeable phase or a magneto optical layer or a dye layer. The record carrier is also envisaged to have a different number of data areas and non-data areas and these areas may have a different arrangement to that described previously. The record carrier may comprise more than one information layer e.g. two, three, four, or more.

The described embodiments of the present invention detail the radiation beam having a certain wavelength. It is envisaged that the radiation beam has a different certain wavelength and the optical scanning device and the record carrier are suitably arranged to operate at this different certain wavelength. The record carrier in the described embodiment of the invention is an optical record carrier, however it is envisaged in further embodiments that the optical scanning device is adapted to scan different types of record carrier including for example a disc employing hybrid recording such as heat assisted magnetic recording (HAMR) or a disc of a hard disc drive (HDD).

In the described embodiments of the present invention, a single radiation beam is used for both the start-up procedure and the scanning procedure. It is alternatively envisaged that different radiation beams generated by different radiation sources may be used for each of the start-up procedure and the scanning procedure.

In the described embodiments of the present invention, the first and second error signals are generated in accordance with detected radiation having a certain polarisation. It is envisaged in further embodiments of the present invention that the first and second error signals may be generated in accordance with radiation having a different characteristic. Furthermore it is envisaged that the second error signal E₂ may be generated by a different detector arrangement to that described; for example, the second error signal E₂ may alternatively be generated using a sum signal produced by the push-pull detector 41. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-13. (canceled)

14. An optical scanning device for scanning a record carrier (22), said record carrier having an outer face (24), wherein said optical scanning device comprises:
a) a radiation source system (2) arranged to generate a radiation beam (3);
b) an objective system (20) having an exit face (45), said objective system being arranged between said radiation source system and said record carrier;
c) a radiation detector arrangement for generating detector signals from said radiation beam, said detector signals representing information detected in the radiation after interaction with the record carrier; and
d) a position control system (42) for controlling a gap size of a gap between the exit face of the objective system and the outer face of the record carrier, the position control system providing for evanescent coupling of the radiation across said gap,
wherein the optical scanning device is arranged to process said detector signals to generate signals which are each indicative of said gap size and are suitable for controlling characteristics of the device during scanning of a record carrier, said signals including a first signal (E₁) for use by the position control system for controlling said gap size, wherein said position control system is arranged to use a characteristic of said first signal to control said gap size,
characterized in that the optical scanning device is arranged to generate said signals including a second signal (E₂), different to said first signal, for use by the position control system for controlling said gap size.

15. An optical scanning device according to claim 14, wherein a characteristic of at least one of said signals is determined by a portion of said radiation reflected towards said radiation detector arrangement by said exit face.

16. An optical scanning device according to claim 14, wherein said position control system is arranged to control said gap size selectively using said first signal or said second signal, said position control system using said first signal when said gap size is relatively small, and using said second signal when said gap size is relatively large.

17. An optical scanning device according to claim 14, wherein said position control system is arranged to use said first signal to control said gap size to maintain an efficient evanescent coupling during a scanning procedure when the optical scanning device is scanning a data area (48) of said record carrier.

18. An optical scanning device according to claim 14, wherein said position control system is arranged to use said second signal to control said gap size during a start-up procedure in which said position control system moves (54) said objective system, relative to said record carrier, from a first position, in which there is no efficient evanescent coupling across said gap, to a second position, in which there is efficient evanescent coupling of the radiation across said gap.

19. An optical scanning device according to claim 18, wherein said position control system includes a servo control system, and wherein said position control system is arranged to use said second signal as an input to said servo control system during said start-up procedure.

20. An optical scanning device according to claim 18, wherein said position control system includes a servo control system, and wherein said position control system is arranged to use said second signal to control an approach of said objective system to said record carrier during said start-up procedure and prior to use of said servo control system.

21. An optical scanning device according to claim 18, wherein said position control system includes a servo control system, and wherein said position control system is arranged to use said second signal to control a handing over (66) to said servo control system during said start-up procedure.

22. An optical scanning device according to claim 14, wherein said optical scanning device includes a plurality of optical detection paths, and wherein said first and second signals are derived from first radiation in a first optical detection path, and second radiation in a second, different, optical detection path, respectively.

23. An optical scanning device according to claim 22, wherein said first radiation and said second radiation are orthogonally polarized with respect to each other.

24. A record carrier (22) for use in an optical scanning device, said record carrier having an outer face (24), wherein said optical scanning device comprises:
a) a radiation source system (2) arranged to generate a radiation beam (3);
b) an objective system (20) having an exit face (45), said objective system being arranged between said radiation source system and said record carrier;
c) a radiation detector arrangement for generating detector signals from said radiation beam, said detector signals representing information detected in the radiation after interaction with the record carrier;
d) a first position control system (42) for controlling a gap size of a gap between the exit face of the objective system and the outer face of the record carrier, the position control system providing for evanescent coupling of the radiation beam across said gap; and
e) a second position control system for controlling positioning of said objective system across the outer face of the record carrier,
wherein said record carrier comprises a scanning area (46) in which said objective system is positionable using said second position control system,
wherein said scanning area includes:
one or more data areas (48) for storing data in data tracks, said data tracks having a predetermined width; and
one or more non-data areas (50, 52) arranged to provide scanning characteristics whereby, when said objective system is positioned in a non-data area by said second positioning system, said radiation detector arrangement is able to generate signals, including a first signal and a second, different, signal, which are indicative of said gap size, and with which said first position control system is able to control said gap size, said one or more non-data areas having a width greater than said predetermined data track width.

25. A record carrier according to claim 24, wherein the scanning area includes a plurality of data areas, and wherein at least one non-data area is located between two of said plurality of data areas.

26. A record carrier according to claim 24, wherein the scanning area includes a plurality of non-data areas located at different positions across said outer face.

27. A method of scanning a record carrier according to claim 24, said method comprising scanning said record carrier using said optical scanning device, said method comprising:
positioning said objective system in a non-data area (50, 52) using said second position control system; and
using said first position control system to control said gap size, using signals, including a first signal and a second, different, signal, which are each indicative of said gap size, and are generated by interaction of said radiation with said non-data area.
